(19) United States
(12) Patent Application Publication
(10) Pub. No.: US 2005/0180674 A1
(43) Pub. Date: Aug. 18, 2005

(54) Faraday structured waveguide display

(75) Inventor: Sutherland Ellwood Jr., Clinton Corners, NY (US)

Correspondence Address: PANORAMA FLAT, C/O PATENT LAW OFFICES OF MICHAEL E. WOODS, 112 BARN ROAD, TIBURON, CA, 94920, US

(73) Assignee: Panorama FLAT Ltd., Perth (AU)

(21) Appl. No.: 10/812,295

(22) Filed: Mar. 29, 2004

Related U.S. Application Data
(60) Provisional application No. 60/544,591, filed on Feb. 12, 2004.

(51) Int. Cl. G02F 1/295

(52) U.S. Cl. 385/6; 385/4; 385/39; 385/40; 385/901

(57) ABSTRACT

Abstract of the Disclosure

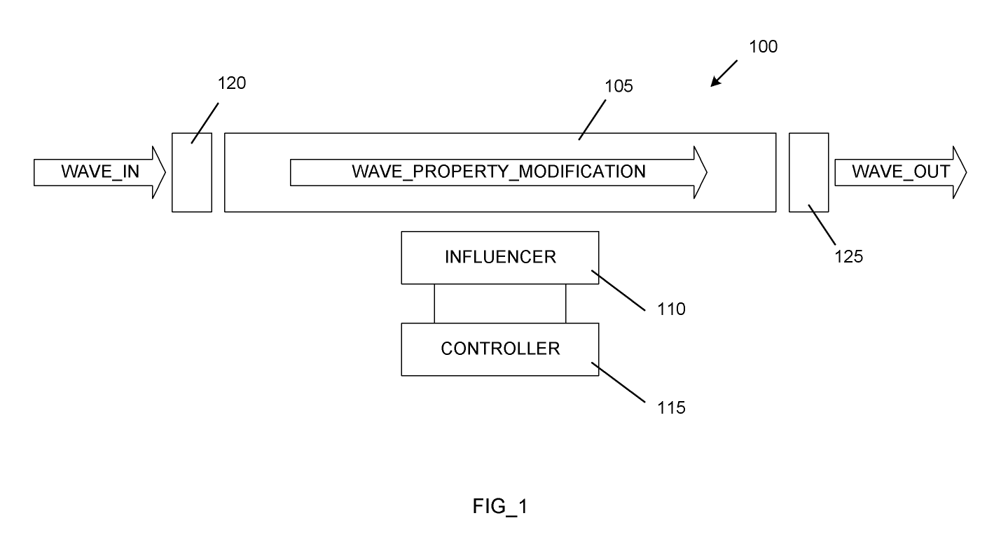

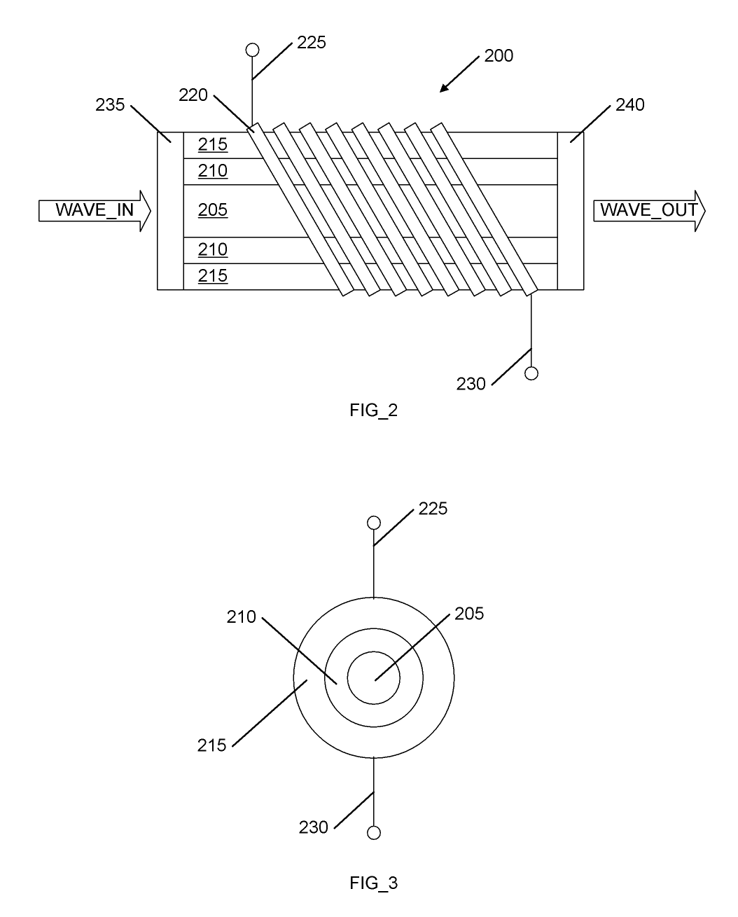

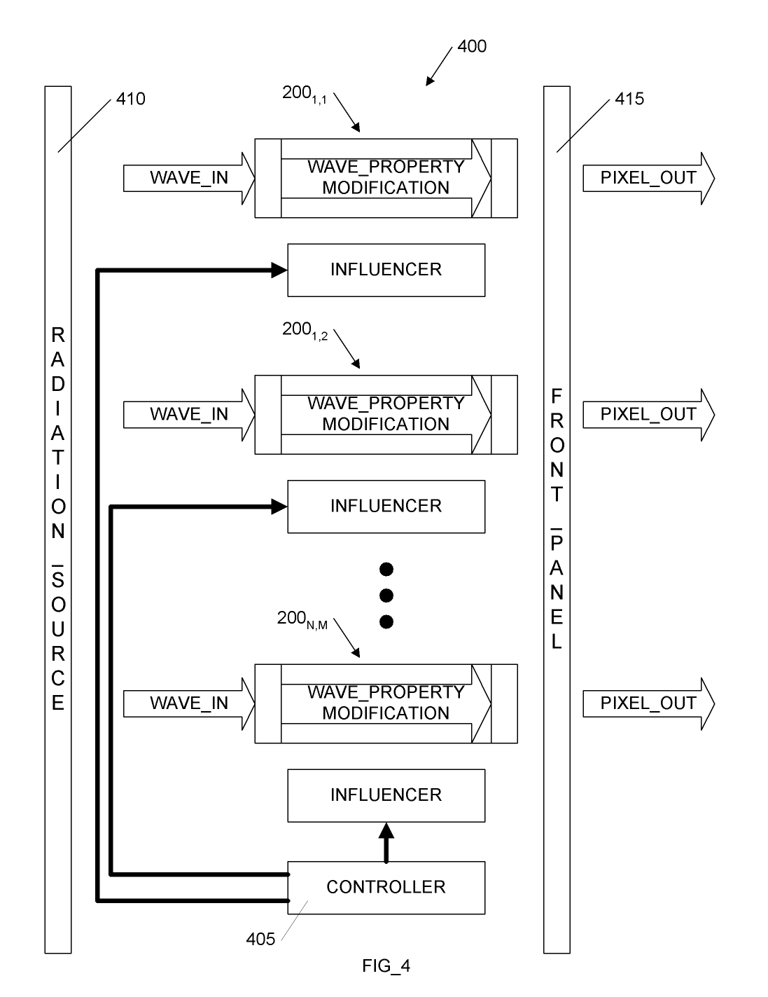

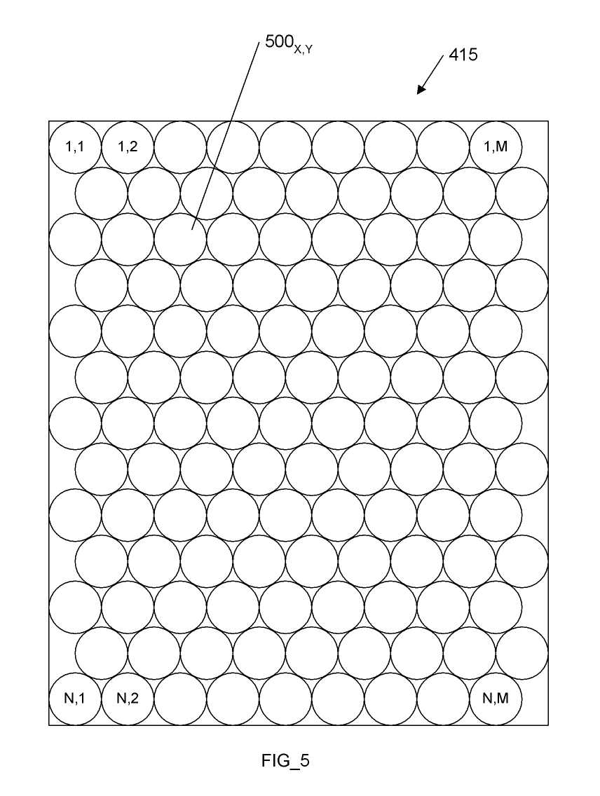

Disclosed is an apparatus and method for an alternative display technology that offers advantages of the prior art while reducing cost and improving performance of flat panel displays and projection systems, the apparatus and method including a display assembly including a radiation source and a plurality of waveguide modulators arranged with output ports forming a desired pixel arrangement, each modulator having a mechanism for controllably influencing one or more predetermined properties of radiation transported through waveguides to modulate an emitted intensity. The display assembly includes a plurality of radiation wave modulators, each modulator having a first element for producing a wave component from a radiation wave, said wave component having a polarization property wherein said polarization property is one of a set of orthogonal polarizations; an optical transport for receiving said wave component; a transport influencer, operatively coupled to said optical transport, for affecting said polarization property of said wave component responsive to a control signal; and a second element for interacting with said affected wave component wherein an intensity of said wave component is varied responsive to said control signal with the assembly further including a radiation source for producing said radiation wave for each said modulator; and a controller, coupled to said modulators, for selectively asserting each said control signal to independently control said intensity of each said modulator. The display method includes producing a radiation wave for each of a plurality of modulators, each modulator having a first element for producing a wave component from said radiation wave, said wave component having a polarization property wherein said polarization property is one of a set of orthogonal polarizations; an optical transport for receiving said wave component; a transport influencer, operatively coupled to said optical transport, for affecting said polarization property of said wave component responsive to a control signal; and a second element for interacting with said affected wave component wherein an intensity of said wave component is varied responsive to said control signal; and the method further including asserting selectively each said control signal to independently control said intensity of each said modulator.

### Detailed Description of the Invention

### CROSS REFERENCE TO RELATED APPLICATIONS

This Application claims priority from US Provisional Application 60/544,591 entitled "SYSTEM, METHOD, AND COMPUTER PROGRAM PRODUCT FOR MAGNETO-OPTIC DEVICE DISPLAY" filed on 12 February 2004, and is related to US Patent Application 10/812,294 entitled "FARADAY STRUCTURED WAVEGUIDE" and is related to US Patent Application 10/811,782 entitled "FARADAY STRUCTURED WAVEGUIDE MODULATOR" both filed on even date herewith and all expressly incorporated by reference for all purposes.

### BACKGROUND OF THE INVENTION

The present invention relates generally to a waveguide display assembly for image/pattern formation using transmitted radiation having one or more predetermined properties, the assembly including a plurality of modulating waveguide structures each having a mechanism for controllably influencing the one or more predetermined properties to vary an intensity of emitted radiation, and more specifically to an aggregation of optical fibers each with a predetermined Verdet profile for transmitting radiation having a particular polarization and an integrated structure for controllably altering the polarization of the radiation as it travels through the fiber including one or more polarization filters to permit an emitted radiation intensity to be varied such that a collective image or pattern is formed at an output.

The Faraday effect is a phenomenon wherein a plane of polarization of linearly polarized light rotates when the light is propagated through a transparent medium placed in a magnetic field and in parallel with the magnetic field. An effectiveness of the magnitude of polarization rotation varies with the strength of the magnetic field, the Verdet constant inherent to the medium and the light path length. The empirical angle of rotation is given by

$$β = VBd$$

(Eq. 1)

where V is called the Verdet constant (and has units of arc minutes cm-1 Gauss-1), B is the magnetic field and d is the propagation distance subject to the field. In the quantum mechanical description, Faraday rotation occurs because imposition of a magnetic field alters the energy levels.

It is known to use discrete materials (e.g., iron-containing garnet crystals) having a high Verdet constant for measurement of magnetic fields (such as those caused by electric current as a way of evaluating the strength of the current) or as a Faraday rotator used in an optical isolator. An optical isolator includes a Faraday rotator to rotate by 45° the plane of polarization, a magnet for application of magnetic field, a polarizer, and an analyzer. Conventional optical isolators have been of the bulk type wherein no fiber is used.

In conventional optics, magneto-optical modulators have been produced from paramagnetic and ferromagnetic materials, particularly garnets (yttrium/iron garnet for example). Devices such as these require considerable magnetic control fields. The magneto-optical effects are also used in thin-layer technology, particularly for producing non-reciprocal devices, such as non-reciprocal junctions. Devices such as these are based on a conversion of modes by Faraday effect or by Cotton-Moutton effect.

A further drawback to using paramagnetic and ferromagnetic materials in magneto-optic devices is that these materials may adversely affect properties of the radiation other than polarization angle, such as for example amplitude, phase, and/or frequency.

The prior art has known the use of discrete magneto-optical bulk devices for collectively defining a display device. These prior art displays have several drawbacks, including a relatively high cost per picture element (pixel), high operating costs for controlling individual pixels, increasing control complexity that does not scale well for relatively large displays devices.

Conventional imaging systems may be roughly divided into two categories: (a) flat panel displays (FPDs), and (b) projection systems (which includes cathode ray tubes (CRTs) as emissive displays). Generally speaking, the dominant technologies for the two types of systems are not the same, although there are exceptions. These two categories have distinct challenges for any prospective technology, and existing technologies have yet to satisfactorily conquer these challenges.

A main challenge confronting existing FPD technology is cost, as compared with the dominant cathode ray tube (CRT) technology ("flat panel" means "flat" compared to a CRT display, whose standard depth is nearly equal to the width of the display area).

To achieve a given set of imaging standards, including resolution, brightness, and contrast, FPD technology is roughly three to four times more expensive than CRT technology. However, the bulkiness and weight of CRT technology, particularly as a display area is scaled larger, is a major drawback. Quests for a thin display has driven the development of a number of technologies in the FPD arena.

High costs of FPD are largely due to the use of delicate component materials in the dominant liquid crystal diode (LCD) technology, or in the less-prevalent gas plasma technology. Irregularities in the nematic materials used in LCDs result in relatively high defect rates; an array of LCD elements in which an individual cell is defective often results in the rejection of an entire display, or a costly substitution of the defective element.

For both LCD and gas-plasma display technology, the inherent difficulty of controlling liquids or gasses in the manufacturing of such displays is a fundamental technical and cost limitation.

An additional source of high cost is the demand for relatively high switching voltages at each light valve/emission element in the existing technologies. Whether for rotating the nematic materials of an LCD display, which in turn changes a polarization of light transmitted through the liquid cell, or excitation of gas cells in a gas plasma display, relatively high voltages are required to achieve rapid switching speeds at the imaging element. For LCDs, an "active matrix, in which individual transistor elements are assigned to each imaging location, is the high-cost solution.

As image quality standards increase, for high-definition television (HDTV) or beyond, existing FPD technologies cannot now deliver image quality at a cost that is competitive with CRT's. The cost differential at this end of the quality range is most pronounced. And delivering 35mm film-quality resolution, while technically feasible, is expected to entail a cost that puts it out of the realm of consumer electronics, whether for televisions or computer displays.

For projection systems, there are two basic subclasses: television (or computer) displays, and theatrical motion picture projection systems. Relative cost is a major issue in the context of competition with traditional 35mm film projection equipment. However, for HDTV, projection systems represent the low-cost solution, when compared against conventional CRTs, LCD FPDs, or gas-plasma FPDs.

Current projection system technologies face other challenges. HDTV projection systems face the dual challenge of minimizing a depth of the display, while maintaining uniform image quality within the constraints of a relatively short throw-distance to the display surface. This balancing typically results in a less-than-satisfactory compromise at the price of relatively lower cost.

A technically-demanding frontier for projection systems, however, is in the domain of the movie theater. Motion-picture screen installations are an emerging application area for projection systems, and in this application, issues regarding console depth versus uniform image quality typically do not apply. Instead, the challenge is in equaling (at minimum) the quality of traditional 35 mm film projectors, at a competitive cost. Existing technologies, including direct Drive Image Light Amplifier ("D-ILA"), digital light processing ("DLP"), and grating-light-valve ("GLV")-based systems, while recently equaling the quality of traditional film projection equipment, have significant cost disparities as compared to traditional film projectors.

Direct Drive Image Light Amplifier is a reflective liquid crystal light valve device developed by JVC Projectors. A driving integrated circuit ("IC") writes an image directly onto a CMOS based light valve. Liquid crystals change the reflectivity in proportion to a signal level. These vertically aligned (homeoptropic) crystals achieve very fast response times with a rise plus fall time less than 16 milliseconds. Light from a xenon or ultra high performance ("UHP") metal halide lamp travels through a polarized beam splitter, reflects off the D-ILA device, and is projected onto a screen.

At the heart of a DLP™ projection system is an optical semiconductor known as a Digital Micromirror Device, or DMD chip, which was pioneered by Dr. Larry Hornbeck of Texas Instruments in 1987. The DMD chip is a sophisticated light switch. It contains a rectangular array of up to 1.3 million hinge-mounted microscopic mirrors; each of these micromirrors measures less than one-fifth the width of a human hair, and corresponds to one pixel in a projected image. When a DMD chip is coordinated with a digital video or graphic signal, a light source, and a projection lens, its mirrors reflect an all-digital image onto a screen or other surface. The DMD and the sophisticated electronics that surround it are called Digital Light Processing™ technology.

A process called GLV (Grating-Light-Valve) is being developed. A prototype device based on the technology achieved a contrast ratio of 3000:1 (typical high-end projection displays today achieve only 1000:1). The device uses three lasers chosen at specific wavelengths to deliver color. The three lasers are: red (642 nm), green (532 nm), and blue (457nm). The process uses MEMS technology (MicroElectroMechanical) and consists of a microribbon array of 1,080 pixels on a line. Each pixel consists of six ribbons, three fixed and three which move up/down. When electrical energy is applied, the three mobile ribbons form a kind of diffraction grating which "filters" out light.

Part of the cost disparity is due to the inherent difficulties those technologies face in achieving certain key image quality parameters at a low cost. Contrast, particularly in quality of "black," is difficult to achieve for micro-mirror DLP. GLV, while not facing this difficulty (achieving a pixel nullity, or black, through optical grating wave interference), instead faces the difficulty of achieving an effectively film-like intermittent image with a line-array scan source.

Existing technologies, either LCD or MEMS-based, are also constrained by the economics of producing devices with at least 1K x 1K arrays of elements (micro-mirrors, liquid crystal on silicon ("LCoS"), and the like). Defect rates are high in the chip-based systems when involving these numbers of elements, operating at the required technical standards.

What is needed is an alternative display technology that offers advantages of the prior art while reducing cost and improving performance of flat panel displays and projection systems.

### BRIEF SUMMARY OF THE INVENTION

Disclosed is an apparatus and method for an alternative display technology that offers advantages of the prior art while reducing cost and improving performance of flat panel displays and projection systems, the apparatus and method including a display assembly including a radiation source and a plurality of waveguide modulators arranged with output ports forming a desired pixel arrangement, each modulator having a mechanism for controllably influencing one or more predetermined properties of radiation transported through waveguides to modulate an emitted intensity. The display assembly includes a plurality of radiation wave modulators, each modulator having a first element for producing a wave component from a radiation wave, the wave component having a polarization property wherein the polarization property is one of a set of orthogonal polarizations; an optical transport for receiving the wave component; a transport influencer, operatively coupled to the optical transport, for affecting the polarization property of the wave component responsive to a control signal; and a second element for interacting with the affected wave component wherein an intensity of the wave component is varied responsive to the control signal with the assembly further including a radiation source for producing the radiation wave for each the modulator; and a controller, coupled to the modulators, for selectively asserting each the control signal to independently control the intensity of each the modulator. The display method includes producing a radiation wave for each of a plurality of modulators, each modulator having a first element for producing a wave component from the radiation wave, the wave component having a polarization property wherein the polarization property is one of a set of orthogonal polarizations; an optical transport for receiving the wave component; a transport influencer, operatively coupled to the optical transport, for affecting the polarization property of the wave component responsive to a control signal; and a second element for interacting with the affected wave component wherein an intensity of the wave component is varied responsive to the control signal; and the method further including asserting selectively each the control signal to independently control the intensity of each the modulator.

The apparatus and method of the present invention provide an advantage of a using an arranged and aggregated collection of modulating waveguides as disclosed in the incorporated patent applications to collectively control individual picture elements of a display device. In a preferred embodiment, the waveguide is an optical transport adapted to enhance the property influencing characteristics of the influencer while preserving desired attributes of the radiation and includes (as discrete components or integrated components polarizing elements to interact with the radiation). In a preferred embodiment, the property of the radiation to be influenced includes a polarization state of the radiation and the influencer uses a Faraday effect to control a polarization rotation angle using a controllable, variable magnetic field propagated parallel to a transmission axis of the optical transport. The optical transport is constructed to enable the polarization to be controlled quickly using low magnetic field strength over very short optical paths. Radiation is initially controlled to produce a wave component having one particular polarization; the polarization of that wave component is influenced so that a second polarizing filter modulates an emitted radiation intensity in response to the influencing effect. In the preferred embodiment, this modulation includes extinguishing the emitted radiation. Modulator outputs are assembled into a desired pattern with each modulator forming a part of the final pattern mosaic. This intensity control is applied to each of the modulators that form part of the pixel pattern to produce a controllable display. The incorporated patent applications disclose Faraday structured waveguides and Faraday structured waveguide modulators that are the preferred pixel control elements of the present invention.

The invention provides for an alternative display technology that offers advantages of the prior art while reducing cost and improving performance of flat panel displays and projection systems.

### BRIEF DESCRIPTION OF THE DRAWINGS

Fig_1 is a general schematic plan view of a preferred embodiment of the present invention;

Fig_2 is a detailed schematic plan view of a specific implementation of the preferred embodiment shown in Fig_1;

Fig_3 is an end view of the preferred embodiment shown in Fig_2;

Fig_4 is a schematic block diagram of a preferred embodiment for a display assembly; and

Fig_5 is a view of one arrangement for output ports of the front panel shown in Fig_4.

### DETAILED DESCRIPTION OF THE INVENTION

The present invention relates to a waveguide display assembly for image/pattern formation using transmitted radiation having one or more predetermined properties, the assembly including a plurality of modulating waveguide structures each having a mechanism for controllably influencing the one or more predetermined properties to vary an intensity of emitted radiation. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the following description, three terms have particular meaning in the context of the present invention: (1) optical transport, (2) property influencer, and (3) extinguishing. For purposes of the present invention, an optical transport is a waveguide particularly adapted to enhance the property influencing characteristics of the influencer while preserving desired attributes of the radiation. In a preferred embodiment, the property of the radiation to be influenced includes its polarization rotation state and the influencer uses a Faraday effect to control the polarization angle using a controllable, variable magnetic field propagated parallel to a transmission axis of the optical transport. The optical transport is constructed to enable the polarization to be controlled quickly using low magnetic field strength over very short optical paths. In such particular implementations, the optical transport includes optical fibers exhibiting high Verdet constants for the wavelengths of the transmitted radiation while concurrently preserving the waveguiding attributes of the fiber and otherwise providing for efficient construction of, and cooperative affectation of the radiation property(ies), by the property influencer.

The property influencer is a structure for implementing the property control of the radiation transmitted by the optical transport. In the preferred embodiment, the property influencer is operatively coupled to the optical transport, which in one implementation for an optical transport formed by an optical fiber having a core and one or more cladding layers, preferably the influencer is integrated into or on one or more of the cladding layers without significantly adversely altering the waveguiding attributes of the optical transport. In the preferred embodiment using the polarization property of transmitted radiation, the preferred implementation of the property influencer is a polarization influencing structure, such as a coil, coilform, or other integratable structure that manifests a Faraday effect in the optical transport (and thus on the transmitted radiation) using one or more magnetic fields (one or more of which are controllable).

The structured waveguide of the present invention serves to modulate an intensity of radiation transmitted by the optical transport. The radiation emitted by the modulator will have a maximum radiation intensity and a minimum radiation intensity, controlled by the interaction of the property influencer on the optical transport. Extinguishing simply refers to the minimum radiation intensity being at a sufficiently low level (as appropriate for the particular embodiment) to be characterized as "off" or "dark" or other classification indicating an absence of radiation. In other words, in some applications a sufficiently low but detectable/discernable radiation intensity may properly be identified as "extinguished" when that level meets the parameters for the implementation or embodiment.

Fig_1 is a general schematic plan view of a preferred embodiment of the present invention for a Faraday structured waveguide modulator 100. Modulator 100 includes an optical transport 105, a property influencer 110 operatively coupled to transport 105, a first property element 120, and a second property element 125.

Transport 105 may be implemented based upon many well-known optical waveguide structures of the art. For example, transport 105 may be a specially adapted optical fiber having a core and one or more cladding layers, or transport 105 may be a waveguide channel of a bulk device or substrate. The conventional waveguide structure is modified based upon the type of radiation property to be influenced and the nature of influencer 110.

Influencer 110 is a structure for manifesting property influence on the radiation transmitted through transport 105 and/or on transport 105. Many different types of radiation properties may be influenced, and in many cases a particular structure used for influencing any given property may vary from implementation to implementation. In the preferred embodiment, properties that may be used in turn to control an output intensity of the radiation are desirable properties for influence. For example, radiation polarization angle is one property that may be influenced and is a property that may be used to control a transmitted intensity of the radiation. Use of another element, such as a fixed polarizer will control radiation intensity based upon the polarization angle of the radiation compared to the transmission axis of the polarizer. Controlling the polarization angle varies the transmitted radiation in this example.

However, it is understood that other types of properties may be influenced as well and may be used to control output intensity, such as for example, radiation phase or radiation frequency. Typically, other elements are used with modulator 100 to control output intensity based upon the nature of the property and the type and degree of the influence on the property. In some embodiments another characteristic of the radiation may be desirably controlled rather than output intensity, which may require that a radiation property other than those identified be controlled, or that the property may need to be controlled differently to achieve the desired control over the desired attribute.

A Faraday effect is but one example of one way of achieving polarization control within transport 105. A preferred embodiment of influencer 110 for Faraday polarization rotation influence uses a combination of variable and fixed magnetic fields proximate to or integrated within/on transport 105. These magnetic fields are desirably generated so that a controlling magnetic field is oriented parallel to a propagation direction of radiation transmitted through transport 105. Properly controlling the direction and magnitude of the magnetic field achieves a desired degree of influence on the radiation polarization angle.

It is preferable in this particular example that transport 105 be constructed to improve/maximize the "influencibility" of the selected property by influencer 110. For the polarization rotation property using a Faraday effect, transport 105 is doped, formed, processed, and/or treated to increase/maximize the Verdet constant. The greater the Verdet constant, the easier influencer 110 is able to influence the polarization rotation angle at a given field strength and transport length. In the preferred embodiment of this implementation, attention to the Verdet constant is the primary task with other features/attributes/characteristics of the waveguide aspect of transport 105 secondary. In the preferred embodiment, influencer 110 is integrated or otherwise "strongly associated" with transport 105, though some implementations may provide otherwise.

Element 120 and element 125 are property elements for selecting/filtering/operating on the desired radiation property to be influenced by influencer 110. Element 120 may be a filter to be used as a "gating" element to pass wave components of the input radiation having a desired state for the appropriate property, or it may be a "processing" element to conform one or more wave components of the input radiation to a desired state for the appropriate property. The gated/processed wave components from element are provided to optical transport 105 and property influencer 110 controllably influences the transported wave components as described above.

Element 125 is a cooperative structure to element 120 and operates on the influenced wave components. Element 125 is a structure that emits WAVE_OUT and controls an intensity of WAVE_OUT based upon a state of the property of the wave component. The nature and particulars of that control relate to the influenced property and the state of the property from element 120 and the specifics of how that initial state has been influenced by influencer 110.

For example, when the property to be influenced is a polarization property/polarization rotation angle of the wave components, element 120 and element 125 may be polarization filters. Element 120 selects one specific type of polarization for the wave component, for example right hand circular polarization. Influencer 110 controls a polarization rotation angle of radiation as it passes through transport 105. Element 125 filters the influenced wave component based upon the final polarization rotation angle as compared to a transmission angle of element 125. In other words, when the polarization rotation angle of the influenced wave component matches the transmission axis of element 125, WAVE_OUT has a high intensity level. When the polarization rotation angle of the influenced wave component is "crossed" with the transmission axis of element 125, WAVE_OUT has a low intensity level. A cross in this context refers to a rotation angle about ninety degrees misaligned with the transmission axis.

Further, it is possible to establish the relative orientations of element 120 and element 125 so that a default condition results in a maximum intensity of WAVE_OUT, a minimum intensity of WAVE_OUT, or some value in between. A default condition refers to a magnitude of the output intensity without influence from influencer 110. For example, by setting the transmission axis of element 125 at a ninety degree relationship to a transmission axis of element 120, the default condition would be a minimum intensity for the preferred embodiment.

Element 120 and element 125 may be discrete components or one or both structures may be integrated onto or into transport 105. In some cases, the elements may be localized at an "input" and an "output" of transport 105 as in the preferred embodiment, while in other embodiments these elements may be distributed in particular regions of transport 105 or throughout transport 105.

In operation, radiation (shown as WAVE_IN) is incident to element 120 and an appropriate property (e.g. a right hand circular polarization (RCP) rotation component) is gated/processed to pass an RCP wave component to transport 105. Transport 105 transmits the RCP wave component until it is interacted with by element 125 and the wave component (shown as WAVE_OUT) is emitted. Incident WAVE_IN typically has multiple orthogonal states to the polarization property (e.g., right hand circular polarization (RCP) and left hand circular polarization (LCP)). Element 120 produces a particular state for the polarization rotation property (e.g., passes one of the orthogonal states and blocks/shifts the other so only one state is passed). Influencer 110, in response to a control signal, influences that particular polarization rotation of the passed wave component and may change it as specified by the control signal. Influencer 110 of the preferred embodiment is able to influence the polarization rotation property over a range of about ninety degrees. Element 125 then interacts with the wave component as it has been influenced permitting the radiation intensity of WAVE_IN to be modulated from a maximum value when the wave component polarization rotation matches the transmission axis of element 125 and a minimum value when the wave component polarization is "crossed" with the transmission axis. By use of element 120, the intensity of WAVE_OUT of the preferred embodiment is variable from a maximum level to an extinguished level.

Fig_2 is a detailed schematic plan view of a specific implementation of the preferred embodiment shown in Fig_1. This implementation is described specifically to simplify the discussion, though the invention is not limited to this particular example. Faraday structured waveguide modulator 100 shown in Fig_1 is a Faraday optical modulator 200 shown in Fig_2.

Modulator 200 includes a core 205, a first cladding layer 210, a second cladding layer 215, a coil or coilform 220 (coil 220 having a first control node 225 and a second control node 230), an input element 235, and an output element 240. Fig_3 is a sectional view of the preferred embodiment shown in Fig_2 taken between element 235 and element 240 with like numerals showing the same or corresponding structures.

Core 205 may contain one or more of the following dopants added by standard fiber manufacturing techniques, e.g., variants on the vacuum deposition method: (a) color dye dopant (makes modulator 200 effectively a color filter alight from a source illumination system), and (b) an optically-active dopant, such as YIG or Tb or TGG or other dopant for increasing the Verdet constant of core 205 to achieve efficient Faraday rotation in the presence of an activating magnetic field. Heating or applying stress to the fiber during manufacturing adds holes or irregularities in core 205 to further increase the Verdet constant and/or implement non-linear effects.

Much silica optical fiber is manufactured with high levels of dopants relative to the silica percentage (this level may be as high as fifty percent dopants). Current dopant concentrations in silica structures of other kinds of fiber achieve about ninety-degree rotation in a distance of tens of microns. Conventional fiber manufacturers continue to achieve improvements in increasing dopant concentration (e.g., fibers commercially available from JDS Uniphase) and in controlling dopant profile (e.g. fibers commercially available from Corning Incorporated). Core 205 achieves sufficiently high and controlled concentrations of optically active dopants to provide requisite quick rotation with low power in micron-scale distances, with these power/distance values continuing to decrease as further improvements are made.

First cladding layer 210 (optional in the preferred embodiment) is doped with ferro-magnetic single-molecule magnets, which become permanently magnetized when exposed to a strong magnetic field. Magnetization of first cladding layer 210 may take place prior to the addition to core 205 or pre-form, or after modulator 200 (complete with core, cladding, coating(s) and/or elements) is drawn. During this process, either the preform or the drawn fiber passes through a strong permanent magnet field ninety degrees offset from a transmission axis of core 205. In the preferred embodiment, this magnetization is achieved by an electro-magnetic disposed as an element of a fiber pulling apparatus. First cladding layer 210 (with permanent magnetic properties) is provided to saturate the magnetic domains of the optically-active core 205, but does not change the angle of rotation of the radiation passing through fiber 200, since the direction of the magnetic field from layer 210 is at right-angles to the direction of propagation. The incorporated provisional application describes a method to optimize an orientation of a doped ferromagnetic cladding by pulverization of non-optimal nuclei in a crystalline structure.

As single-molecule magnets (SMMs) are discovered that may be magnetized at relative high temperatures, the use of these SMMs will be preferable as dopants. The use of these SMMs allow for production of superior doping concentrations and dopant profile control. Examples of commercially available single-molecule magnets and methods are available from ZettaCore, Inc. of Denver, Colorado.

Second cladding layer 215 is doped with a ferrimagnetic or ferromagnetic material and is characterized by an appropriate hysteresis curve. The preferred embodiment uses a "short" curve that is also "wide" and "flat," when generating the requisite field. When second cladding layer 215 is saturated by a magnetic field generated by an adjacent field-generating element (e.g. coil 220), itself driven by a signal (e.g., a control pulse) from a controller such as a switching matrix drive circuit (not shown), second cladding layer 215 quickly reaches a degree of magnetization appropriate to the degree of rotation desired for modulator 200. Further, second cladding layer 215 remains magnetized at or sufficiently near that level until a subsequent pulse either increases (current in the same direction), refreshes (no current or a +/- maintenance current), or reduces (current in the opposite direction) the magnetization level. This remanent flux of doped second cladding layer 215 maintains an appropriate degree of rotation over time without constant application of a field by influencer 110 (e.g., coil 220).

Appropriate modification/optimization of the doped ferri/ferromagnetic material may be further effected by ionic bombardment of the cladding at an appropriate process step. Reference is made to US Patent No. 6,103,010 entitled "METHOD OF DEPOSITING A FERROMAGNETIC FILM ON A WAVEGUIDE AND A MAGNETO-OPTIC COMPONENT COMPRISING A THIN FERROMAGNETIC FILM DEPOSITED BY THE METHOD" and assigned to Alcatel of Paris, France in which ferromagnetic thin-films deposited by vapor-phase methods on a waveguide are bombarded by ionic beams at an angle of incidence that pulverizes nuclei not ordered in a preferred crystalline structure. Alteration of crystalline structure is a method known to the art, and may be employed on a doped silica cladding, either in a fabricated fiber or on a doped preform material. The ‘010 patent is hereby expressly incorporated by reference for all purposes.

Similar to first cladding layer 210, suitable single-molecule magnets (SMMs) that are developed and which may be magnetized at relative high temperatures will be preferable as dopants in the preferred embodiment for second cladding layer 215 to allow for superior doping concentrations.

Coil 220 of the preferred embodiment is fabricated integrally on or in fiber 200 to generate an initial magnetic field. This magnetic field from coil 220 rotates the angle of polarization of radiation transmitted through core 205 and magnetizes the ferri/ferromagnetic dopant in second cladding layer 215. A combination of these magnetic fields maintains the desired angle of rotation for a desired period (such a time of a video frame when a matrix of fibers 200 collectively form a display as described in one of the related patent applications incorporated herein). For purposes of the present discussion, a "coilform" is defined as a structure similar to a coil in that a plurality of conductive segments are disposed parallel to each other and at right-angles to the axis of the fiber. As materials performance improves - that is, as the effective Verdet constant of a doped core increases by virtue of dopants of higher Verdet constant (or as augmented structural modifications, including those introducing non-linear effects) - the need for a coil or "coilform" surrounding the fiber element may be reduced or obviated, and simpler single bands or Gaussian cylinder structures will be practical. These structures, when serving the functions of the coilform described herein, are also included within the definition of coilform

When considering the variables of the equation specifying the Faraday effect: field strength, distance over which the field is applied, and the Verdet constant of the rotating medium, one consequence is that structures, components, and/or devices using modulator 200 are able to compensate for a coil or coilform formed of materials that produce less intense magnetic fields. Compensation may be achieved by making modulator 200 longer, or by further increasing/improving the effective Verdet constant. For example, in some implementations, coil 220 uses a conductive material that is a conductive polymer that is less efficient than a metal wire. In other implementations, coil 220 uses wider but fewer windings than otherwise would be used with a more efficient material. In still other instances, such as when coil 220 is fabricated by a convenient process but produces coil 220 having a less efficient operation, other parameters compensate as necessary to achieve suitable overall operation.

This recognizes that there are tradeoffs between design parameters -fiber length, Verdet constant of core, and peak field output and efficiency of the field-generating element. Taking these tradeoffs into consideration produces four preferred embodiments of an integrally-formed coilform, including: (1) twisted fiber to implement a coil/coilform, (2) fiber wrapped epitaxially with a thinfilm printed with conductive patterns to achieve multiple layers of windings, (3) printed by dip-pen nanolithography on fiber to fabricate a coil/coilform, and (4) coil/coilform wound with coated/doped glass fiber, or alternatively a conductive polymer that is metallically coated or uncoated, or a metallic wire. Further details of these embodiments are described in the related and incorporated provisional patent application referenced above.

Node 225 and node 230 receive a signal for inducing generation of the requisite magnetic fields in core 205, cladding layer 215, and coil 220. This signal in a simple embodiment is a DC (direct current) signal of the appropriate magnitude and duration to create the desired magnetic fields and rotate the polarization angle of the WAVE_IN radiation propagating through modulator 200. A controller (not shown) may provide this control signal when modulator 200 is used.

Input element 235 and output element 240 are polarization filters in the preferred embodiment, provided as discrete components or integrated into/onto core 205. Input element 235, as a polarizer, may be implemented in many different ways. Various polarization mechanisms may be employed that permit passage of light of a single polarization type (specific circular or linear) into core 205; the preferred embodiment uses a thin-film deposited epitaxially on an "input" end of core 205. An alternate preferred embodiment uses commercially available nano-scale microstructuring techniques on waveguide 200 to achieve polarization filtering (such as modification to silica in core 205 or a cladding layer as described in the incorporated Provisional Patent Application.) In some implementations for efficient input of light from one or more light source(s), a preferred illumination system may include a cavity to allow repeated reflection of light of the "wrong" initial polarization; thereby all light ultimately resolves into the admitted or "right" polarization. Optionally, especially depending on the distance from the illumination source to modulator 200, polarization-maintaining waveguides (fibers, semiconductor) may be employed.

Output element 240 of the preferred embodiment is a "polarization filter" element that is ninety degrees offset from the orientation of input element 235 for a default "off" modulator 200. (In some embodiments, the default may be made "on" by aligning the axes of the input and output elements. Similarly, other defaults such as fifty percent intensity may be implemented by appropriate relationship of the input and output elements and suitable control from the influencer.) Element 240 is preferably a thin-film deposited epitaxially on an output end of core 205. Input element 235 and output element 240 may be configured differently than described here using other polarization filter/control systems. When the radiation property to be influenced includes a property other than a radiation polarization angle (e.g., phase or frequency), other input and output functions are used to properly gate/process/filter the desired property as described above to modulate the intensity of WAVE_OUT responsive to the influencer.

Fig_4 is a schematic block diagram of a preferred embodiment for a display assembly 400. Assembly 400 includes an aggregation of a plurality of picture elements (pixels) each generated by a waveguide modulator 200i,j such as shown in Fig_2. Control signals for control of each influencer of modulators 200i,j are provided by a controller 405. A radiation source 410 provides source radiation for input/control by modulators 200i,j and a front panel may be used to arrange modulators 200i,j into a desired pattern and.or optionally provide post-output processing of one or more pixels.

Radiation source 410 may be unitary balanced-white or separate RGB/CMY tuned source or sources or other appropriate radiation frequency. Source(s) 410 may be remote from input ends of modulator 200i,j, adjacent these input ends, or integrated onto/into modulator 200i,j. In some implementations, a single source is used, while other implementations may use several or more (and in some cases, one source per modulator 200i,j).

As discussed above, the preferred embodiment for the optical transport of modulator 200i,j includes light channels in the form of special optical fibers. But semiconductor waveguide, waveguiding holes, or other optical waveguiding channels, including channels or regions formed through material "in depth," are also encompassed within the scope of the present invention. These waveguiding elements are fundamental imaging structures of the display and incorporate, integrally, intensity modulation mechanisms and color selection mechanisms. In the preferred embodiment for an FPD implementation, a length of each of the light channels is preferably on the order of about tens of microns (though the length may be different as described herein).

It is one feature of the preferred embodiment that a length of the optical transport is short (on the order of about 20mm and shorter), and able to be continually shortened as the effective Verdet value increases and/or the magnetic field strength increases. The actual depth of a display will be a function of the channel length but because optical transport is a waveguide, the path need not be linear from the source to the output (the path length). In other words, the actual path may be bent to provide an even shallower effective depth in some implementations. The path length, as discussed above, is a function of the Verdet constant and the magnetic field strength and while the preferred embodiment provides for very short path lengths of a few millimeters and shorter, longer lengths may be used in some implementations as well. The necessary length is determined by the influencer to achieve the desired degree of influence/control over the input radiation. In the preferred embodiment for polarized radiation, this control is able to achieve about a ninety degree rotation. In some applications, when an extinguishing level is higher (e.g., brighter) then less rotation may be used which shortens the necessary path length. Thus, the path length is also influenced by the degree of desired influence on the wave component.

Controller 405 includes a number of alternatives for construction and assembly of a suitable switching system. The preferred implementation includes not only a point-to-point controller, it also encompasses a "matrix" that structurally combines and holds modulators 200i,j, and electronically addresses each pixel. In the case of optical fibers, inherent in the nature of a fiber component is the potential for an all-fiber, textile construction and appropriate addressing of the fiber elements. Flexible meshes or solid matrixes are alternative structures, with attendant assembly methods.

It is one feature of the preferred embodiment that an output end of one or more modulators 200i,j may be processed to improve its application. For example, the output ends of the waveguide structures, particularly when implemented as optical fibers, may be heat-treated and pulled to form tapered ends or otherwise abraded, twisted, or shaped for enhanced light scattering at the output ends, thereby improving viewing angle at the display surface. Some and/or all of the modulator output ends may be processed in similar or dissimilar ways to collectively produce a desired output structure achieving the desired result. For example, various focus, attenuation, color or other attribute(s) of the WAVE_OUT from one or more pixels may be controlled or affected by the processing of one or more output ends/corresponding panel location(s).

Front panel 415 may be simply a sheet of optical glass or other transparent optical material facing the polarization component or it may include additional functional and structural features. For example, panel 415 may include guides or other structures to arrange output ends of modulators 200i,j into the desired relative orientation with neighboring modulators 200i,j. Fig_5 is a view of one arrangement for output ports 500x,y of front panel 415 shown in Fig_4. Other arrangements are possible are also possible depending upon the desired display (e.g, circular, elliptical or other regular/irregular geometric shape) When an application requires it, the active display area does not have to be contiguous pixels such that rings or "doughnut" displays are possible when appropriate. In other implementations, output ports may focus, disperse, filter, or perform other type of post-output processing on one or more pixels.

An optical geometry of a display or projector surface may itself vary in which waveguide ends terminate to a desired three-dimensional surface (e.g., a curved surface) which allows additional focusing capacity in sequence with additional optical elements and lenses (some of which may be included as part of panel 415). Some applications may require multiple areas of concave, flat, and/or convex surface regions, each with different curvatures and orientations with the present invention providing the appropriate output shape. In some applications, the specific geometry need not be fixed but may be dynamically alterable to change shapes/orientations/dimensions as desired. Implementations of the present invention may produce various types of haptic display systems as well.

In projection system implementations, radiation source 410, a "switching assembly" with controller 405 coupled to modulators 200i,j, and front panel 415 may benefit from being housed in distinct modules or units, at some distance from each other. Regarding radiation source 410, in some embodiments it is advantageous to separate the illumination source(s) from the switching assembly due to heat produced by the types of high-intensity light that is typically required to illuminate a large theatrical screen. Even when multiple illumination sources are used, distributing the heat output otherwise concentrated in, for instance, a single Xenon lamp, the heat output may still be large enough that the separation from the switching and display elements may be desirable. The illumination source(s) thus would be housed in an insulated case with heat sink and cooling elements. Fibers would then convey the light from the separate or unitary source to the switching assembly, and then projected onto the screen. The screen may include some features of front panel 415 or panel 415 may be used prior to illuminating an appropriate surface.

The separation of the switching assembly from the projection/display surface may have its own advantages. Placing the illumination and switching assembly in a projection system base (the same would hold true for an FPD) is able to reduce the depth of a projection TV cabinet. Or, the projection surface may be contained in a compact ball at the top of a thin lamp-like pole or hanging from the ceiling from a cable, in front projection systems employing a reflective fabric screen.

For theatrical projection, the potential to convey the image formed by the switching assembly, by means of waveguide structures from a unit on the floor, up to a compact final-optics unit at the projection window area, suggests a space-utilization strategy to accommodate both a traditional film projector and a new projector of the preferred embodiment in the same projection room, among other potential advantages and configurations.

A monolithic construction of waveguide strips, each with multiple thousands of waveguides on a strip, arranged or adhered side by side, may accomplish hi-definition imaging. However, "bulk" fiber optic component construction may also accomplish the requisite small projection surface area in the preferred embodiment. Single-mode fibers (especially without the durability performance requirements of external telecommunications cable) have a small enough diameter that the cross-sectional area of a fiber is quite small and suitable as a display pixel or subpixel.

In addition, integrated optics manufacturing techniques are expected to soon permit attenuator arrays of the present invention to be accomplished in the fabrication of a single semiconductor substrate or chip, massively monolithic or superficial.

In a fused-fiber projection surface, the fused-fiber surface may be then ground to achieve a curvature for the purpose of focusing an image into an optical array; alternatively, fiber-ends that are joined with adhesive or otherwise bound may have shaped tips and may be arranged at their terminus in a shaped matrix to achieve a curved surface, if necessary.

For projection televisions or other non-theatrical projection applications, the option of separating the illumination and switching modules from the projector surface suggests novel ways of achieving less-bulky projection television cabinet construction.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A "computer-readable medium" for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A "processor" or "process" includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in "real time," "offline," in a "batch mode," etc. Portions of processing can be performed at different times and at different locations, by different (or the same) processing systems.

Reference throughout this specification to "one embodiment", "an embodiment", "a preferred embodiment" or "a specific embodiment" means that a particular feature, structure, or characteristic described in connection with the embodiment is included in at least one embodiment of the present invention and not necessarily in all embodiments. Thus, respective appearances of the phrases "in one embodiment", "in an embodiment", or "in a specific embodiment" in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term "or" as used herein is generally intended to mean "and/or" unless otherwise indicated. Combinations of components or steps will also be considered as being noted, where terminology is foreseen as rendering the ability to separate or combine is unclear.

As used in the description herein and throughout the claims that follow, "a", "an", and "the" includes plural references unless the context clearly dictates otherwise. Also, as used in the description herein and throughout the claims that follow, the meaning of "in" includes "in" and "on" unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A display assembly, comprising:
a plurality of radiation wave modulators, each modulator including:
a first element for producing a wave component from a radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal;
a radiation source for producing said radiation wave for each said modulator; and
a controller, coupled to said modulators, for selectively asserting each said control signal to independently control said intensity of each said modulator.

2. The assembly of claim 1 wherein said first element and said second element are polarization filters.

3. The assembly of claim 1 wherein said elements are integrated into said transport.

4. The assembly of claim 1 wherein said influencer produces a controllable magnetic field parallel to a propagation direction of said wave through said transport to alter said polarization property.

5. The assembly of claim 1 wherein said influencer alters said polarization property by changing a rotation angle of said wave component in a range from about zero degrees to about ninety degrees.

6. The assembly of claim 1 wherein said transport is a fiber waveguide including a core and a cladding and wherein said influencer includes a magnetic material proximate said cladding.

7. The assembly of claim 6 wherein said magnetic material includes permanent magnetic material.

8. The assembly of claim 6 wherein said magnetic material is selectively magnetized responsive to an electric current.

9. The assembly of claim 6 wherein said magnetic material is integrated into said fiber waveguide.

10. The assembly of claim 5 wherein said elements are circular polarization filters having a crossed transmission orientation.

11. The assembly of claim 5 wherein said elements are circular polarization filters having an aligned transmission orientation.

12. The assembly of claim 1 wherein one or more of said wave components may be extinguished responsive to preselected control signals from said controller to one or more corresponding modulators.

13. The assembly of claim 1 wherein said modulators each have an output port for producing said wave component with said influencer controlled intensity.

14. The assembly of claim 13 wherein said output ports are arranged into a display pattern.

15. The assembly of claim 14 wherein said display pattern is a regular ordered matrix of N rows and M columns.

16. The assembly of claim 13 further comprising a front panel for arranging said output ports into said pattern.

17. The assembly of claim 16 wherein said front panel includes a pixel effect element proximate each corresponding output port.

18. The assembly of claim 17 wherein each said pixel effect element disperses said wave component from said corresponding output port.

19. A display method, the method comprising:
producing a radiation wave for each of a plurality of modulators, each modulator including:
a first element for producing a wave component from said radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal; and
asserting selectively each said control signal to independently control said intensity of each said modulator.

20. The method of claim 19 wherein said first element and said second element are polarization filters.

21. The method of claim 19 wherein said elements are integrated into said transport.

22. The method of claim 19 including producing a controllable magnetic field parallel to a propagation direction of said wave through said transport to alter said polarization property.

23. The method of claim 19 including altering said polarization property by changing a rotation angle of said wave component in a range from about zero degrees to about ninety degrees.

24. The method of claim 19 wherein said transport is a fiber waveguide including a core and a cladding and wherein said influencer includes a magnetic material proximate said cladding.

25. The method of claim 24 wherein said magnetic material includes permanent magnetic material.

26. The method of claim 24 including selectively magnetizing said magnetic material responsive to an electric current.

27. The method of claim 24 wherein said magnetic material is integrated into said fiber waveguide.

28. The method of claim 23 wherein said elements are circular polarization filters having a crossed transmission orientation.

29. The method of claim 23 wherein said elements are circular polarization filters having an aligned transmission orientation.

30. The method of claim 19 wherein one or more of said wave components may be extinguished responsive to preselected control signals from said controller to one or more corresponding modulators.

31. The method of claim 19 wherein said modulators each have an output port for producing said wave component with said influencer controlled intensity.

32. The method of claim 31 wherein said output ports are arranged into a display pattern.

33. The method of claim 32 wherein said display pattern is a regular ordered matrix of N rows and M columns.

34. The method of claim 31 further comprising a front panel for arranging said output ports into said pattern.

35. The method of claim 32 wherein said front panel includes a pixel effect element proximate each corresponding output port.

36. The method of claim 35 wherein each said pixel effect element disperses said wave component from said corresponding output port.

37. A display apparatus, comprising:
means for producing a radiation wave for each of a plurality of means for modulating, each including:
a first element means for producing a wave component from said radiation wave, said wave component having a polarization property wherein said polarization property is one of a set of orthogonal polarizations;
an optical transport means for receiving said wave component;
a transport influencer means, operatively coupled to said optical transport, for affecting said polarization property of said wave component responsive to a control signal; and
a second element means for interacting with said affected wave component wherein an intensity of said wave component is varied responsive to said control signal; and
means for asserting selectively each said control signal to independently control said intensity of each said modulator.

38. The apparatus of claim 37 wherein said first element means and said second element means include polarization filters.

39. The apparatus of claim 37 wherein said elements means are integrated into said transport.

40. The apparatus of claim 37 including a means for producing a controllable magnetic field parallel to a propagation direction of said wave through said transport means to alter said polarization property.

41. The apparatus of claim 37 including a means for altering said polarization property by changing a rotation angle of said wave component in a range from about zero degrees to about ninety degrees.

42. The apparatus of claim 37 wherein said transport means includes a fiber waveguide including a core and a cladding and wherein said influencer means includes a magnetic material proximate said cladding.

43. The apparatus of claim 42 wherein said magnetic material includes permanent magnetic material.

44. The apparatus of claim 42 including means for selectively magnetizing said magnetic material responsive to an electric current.

45. The apparatus of claim 42 wherein said magnetic material is integrated into said fiber waveguide.

46. The apparatus of claim 41 wherein said elements means include circular polarization filters having a crossed transmission orientation.

47. The apparatus of claim 41 wherein said elements means includes circular polarization filters having an aligned transmission orientation.

48. The apparatus of claim 41 wherein one or more of said wave components may be extinguished responsive to preselected control signals from said controller means to one or more corresponding modulator means.

49. The apparatus of claim 37 wherein said modulator means each have an output port for producing said wave component with said influencer means controlled intensity.

50. The apparatus of claim 31 wherein said output ports are arranged into a display pattern.

51. The apparatus of claim 50 wherein said display pattern is a regular ordered matrix of N rows and M columns.

52. The apparatus of claim 49 further comprising a front panel for arranging said output ports into said pattern.

53. The apparatus of claim 50 wherein said front panel includes a means for effecting each proximate each corresponding output port.

54. The apparatus of claim 53 wherein each said effecting means disperses said wave component from said corresponding output port.

55. A computer program product comprising a computer readable medium carrying program instructions for a display when executed using a computing system, the executed program instructions executing a method, the method comprising:
producing a radiation wave for each of a plurality of modulators, each modulator including:
a first element for producing a wave component from said radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal; and
asserting selectively each said control signal to independently control said intensity of each said modulator.

56. The computer program product of claim 55 wherein said first element and said second element are polarization filters.

57. The computer program product of claim 55 wherein said elements are integrated into said transport.

58. The computer program product of claim 55 including producing a controllable magnetic field parallel to a propagation direction of said wave through said transport to alter said polarization property.

59. The computer program product of claim 55 including altering said polarization property by changing a rotation angle of said wave component in a range from about zero degrees to about ninety degrees.

60. The computer program product of claim 55 wherein said transport is a fiber waveguide including a core and a cladding and wherein said influencer includes a magnetic material proximate said cladding.

61. The computer program product of claim 60 wherein said magnetic material includes permanent magnetic material.

62. The computer program product of claim 60 including selectively magnetizing said magnetic material responsive to an electric current.

63. The computer program product of claim 60 wherein said magnetic material is integrated into said fiber waveguide.

64. The computer program product of claim 59 wherein said elements are circular polarization filters having a crossed transmission orientation.

65. The computer program product of claim 59 wherein said elements are circular polarization filters having an aligned transmission orientation.

66. The computer program product of claim 55 wherein one or more of said wave components may be extinguished responsive to preselected control signals from said controller to one or more corresponding modulators.

67. The computer program product of claim 55 wherein said modulators each have an output port for producing said wave component with said influencer controlled intensity.

68. The computer program product of claim 67 wherein said output ports are arranged into a display pattern.

69. The computer program product of claim 68 wherein said display pattern is a regular ordered matrix of N rows and M columns.

70. The computer program product of claim 67 further comprising a front panel for arranging said output ports into said pattern.

71. The computer program product of claim 68 wherein said front panel includes a pixel effect element proximate each corresponding output port.

72. The computer program product of claim 71 wherein each said pixel effect element disperses said wave component from said corresponding output port.

73. A propagated signal on which is carried computer-executable instructions which when executed by a computing system performs a method, the method comprising:
producing a radiation wave for each of a plurality of modulators, each modulator including:
a first element for producing a wave component from said radiation wave, said wave component having a polarization property wherein said polarization property is one of a set of orthogonal polarizations;
an optical transport for receiving said wave component;
a transport influencer, operatively coupled to said optical transport, for affecting said polarization property of said wave component responsive to a control signal; and
a second element for interacting with said affected wave component wherein an intensity of said wave component is varied responsive to said control signal; and
asserting selectively each said control signal to independently control said intensity of each said modulator.

74. The signal of claim 73 wherein said first element and said second element are polarization filters.

75. The signal of claim 73 wherein said elements are integrated into said transport.

76. The signal of claim 73 including producing a controllable magnetic field parallel to a propagation direction of said wave through said transport to alter said polarization property.

77. The signal of claim 73 including altering said polarization property by changing a rotation angle of said wave component in a range from about zero degrees to about ninety degrees.

78. The signal of claim 73 wherein said transport is a fiber waveguide including a core and a cladding and wherein said influencer includes a magnetic material proximate said cladding.

79. The signal of claim 78 wherein said magnetic material includes permanent magnetic material.

80. The signal of claim 78 including selectively magnetizing said magnetic material responsive to an electric current.

81. The signal of claim 78 wherein said magnetic material is integrated into said fiber waveguide.

82. The signal of claim 77 wherein said elements are circular polarization filters having a crossed transmission orientation.

83. The signal of claim 77 wherein said elements are circular polarization filters having an aligned transmission orientation.

84. The signal of claim 73 wherein one or more of said wave components may be extinguished responsive to preselected control signals from said controller to one or more corresponding modulators.

85. The signal of claim 73 wherein said modulators each have an output port for producing said wave component with said influencer controlled intensity.

86. The signal of claim 85 wherein said output ports are arranged into a display pattern.

87. The signal of claim 86 wherein said display pattern is a regular ordered matrix of N rows and M columns.

88. The signal of claim 85 further comprising a front panel for arranging said output ports into said pattern.

89. The signal of claim 86 wherein said front panel includes a pixel effect element proximate each corresponding output port.

90. The signal of claim 89 wherein each said pixel effect element disperses said wave component from said corresponding output port.
